(19) United States
(12) Patent Application Publication
(10) Pub. No.: US 2010/0291462 A1
(43) Pub. Date: Nov. 18, 2010

(54) METHOD FOR PRODUCING MEMBRANES COATED WITH A CATALYST ON BOTH SIDES

(76) Inventors: Sven Thate, Neuleiningen (DE); Alexander Khvorost, Laudenbach (DE); Helmut Moehwald, Annweiler (DE); Ingolf Hennig, Neulussheim (DE)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/063,202

(22) PCT Filed: Aug. 15, 2006
(86) PCT No.: PCT/EP06/65310

§ 371 Date: Feb. 7, 2008

(30) Foreign Application Priority Data
Aug. 16, 2005 (JP) 10 2005 038 612.1

(51) Int. Cl. H01M 8/10

(52) U.S. Cl. 429/483; 429/535

(57) ABSTRACT

The invention relates to a process for producing catalyst coated membranes for electrochemical devices, which comprises the steps
A) production of a first semifinished product by
   application of a first ionomer layer to a first carrier,
   application of an anode catalyst layer to the first ionomer layer using a first catalyst ink,
   drying of the anode catalyst layer,
B) production of a second semifinished product by
   application of a second ionomer layer to a second carrier,
   application of a cathode catalyst layer to the second ionomer layer using a second catalyst ink,
   drying of the cathode catalyst layer,
C) removal of the first and second carrier from the first and second ionomer layer, respectively, and joining of the first semifinished product to the second semifinished product by joining of the first ionomer layer to the second ionomer layer.

The invention relates to a process for producing a polymer electrolyte membrane which is coated with catalyst on both sides (“catalyst coated membrane”=CCM) for electrochemical devices, for example fuel cells, electrochemical sensors or electrolyzers. The invention further relates to a process for producing a membrane-electrode assembly and a catalyst coated membrane.

Fuel cells are energy converters which convert chemical energy into electric energy. In a fuel cell, the principle of electrolysis is reversed. Here, a fuel (for example hydrogen) and an oxidant (for example oxygen) are converted into electric current, water and heat in separate locations at two electrodes. Various types of fuel cells which generally differ from one another in the operating temperature are known today. However, the structure of the cells is in principle the same in all types. They generally comprise two electrodes, an anode and a cathode at which the reactions occur and an electrolyte between the two electrodes. In a polymer electrolyte membrane fuel cell (PEM fuel cell), a polymer membrane which conducts ions (in particular H⁺ ions) is used as electrolyte. The electrolyte has three functions. It establishes ionic contact, prevents electrical contact and in addition serves to keep the gases supplied to the electrodes separate. The electrodes are generally supplied with gases which are reacted in a redox reaction. The electrodes have the task of supplying the gases (for example hydrogen or methanol and oxygen or air), taking away reaction products such as water or CO₂ and taking away or supplying the starting materials to be reacted catalytically and electrons. The conversion of chemical energy into electric energy takes place at the three-phase boundary of catalytically active centers (for example platinum), ion conductors (for example ion-exchange polymers), electron conductors (for example graphite) and gases (for example H₂ and O₂). A very high active area is important for the catalysts.

The key component of a PEM fuel cell is a catalyst coated membrane (CCM) or a membrane-electrode assembly (MEA). In this context, a catalyst coated membrane (CCM) is a polymer electrolyte membrane which is coated with catalyst on both sides and consequently has a three-layer structure comprising an outer anode catalyst layer on one side of a membrane layer, the central membrane layer and an outer cathode catalyst layer on the opposite side of the membrane layer from the anode catalyst layer. The membrane layer comprises proton-conducting polymer materials which will hereinafter be referred to as ionomers. The catalyst layers comprise catalytically active components which catalyze the respective reaction at the anode or cathode (for example oxidation of hydrogen, reduction of oxygen). As catalytically active components, preference is given to using the metals of the platinum group of the Periodic Table of the Elements.

The membrane-electrode assembly comprises a catalyst coated membrane and at least one gas diffusion layer (GDL). The gas diffusion layers serve to supply gas to the catalyst layers and to carry away the cell current.

Membrane-electrode assemblies are known from the prior art, for example from WO 2005/006473 A2. The membrane-electrode assembly described therein comprises an ion-conducting membrane having a front and rear side, a first catalyst layer and a first gas diffusion layer on the front side and a second catalyst and a second gas diffusion layer on the rear side, with the first gas diffusion layer having a smaller area than the ion-conducting membrane and the second gas diffusion layer having essentially the same area as the ion-conducting membrane.

WO 00/10216 A1 relates to a membrane-electrode assembly comprising a polymer electrolyte membrane having a central region and a peripheral region. One electrode is arranged over the central region and part of the peripheral region of the polymer electrolyte membrane. A sub-gasket is arranged on the peripheral region of the polymer electrolyte membrane so that it also extends over part of the electrode which extends into the peripheral region of the polymer electrolyte membrane and a further gasket is arranged at least partly on the sub-gasket.

Many processes for producing membrane-electrode assemblies are known to those skilled in the art. DE 199 10 773 A1 describes, for example, a process for applying electrode layers onto a tape-like polymer electrolyte membrane. Here, the front and rear sides of the membrane are continuously printed with the electrode layers in the desired pattern using an ink comprising an electrocatalyst and the electrode layers which have been printed on are dried at elevated temperature immediately after the printing step, with printing being carried out with maintenance of a precisely positioned arrangement of the pattern of the electrode layers on front and rear sides relative to one another. A problem here is that the membrane material begins to swell on contact with the solvent-containing ink and becomes deformed.

To avoid this, WO 02/039525 A1 proposes a production process in which a catalyst solution is applied to a carrier and the catalyst solution is dried before an ionomer solution is applied to the catalyst layer formed. The layer of ionomer solution is cured. Two catalyst-ionomer composite layers produced in this way are joined to form a membrane-electrode assembly. The process proposed in WO 02/039525 A1 has the disadvantage that the catalyst layer tends, as a result of application to the carrier, to form a dense ionomer skin thereon, and this hinders gas transport into the catalyst layer. This is described, for example, in Xie, Garzon, Zawodzinski, Smith: Ionomer Segregation in Composite MEAs and Its Effect on Polymer Electrolyte Fuel Cell Performance, Journal of The Electrochemical Society, 151 (7) A1084-A1093 (2004). Furthermore, the risk of the porous catalyst layer being damaged during removal from the carrier material is significantly greater than when a homogeneous membrane layer is separated from a carrier film. In addition, the ink has to be optimized so that it displays a good application and wetting behavior on the carrier film.

EP 1 492 184 A1 describes a process for producing a catalyst coated membrane for electrochemical devices. In this process, a polymer electrolyte membrane which is joined on the rear side to a first support film is used. After coating of the front side, a second support film is applied to the front side, the first support film is removed and the second catalyst layer is subsequently applied to the rear side. In this process, the membrane is joined to at least one support film in all coating steps. The support film prevents the swelling of the membrane on application of the catalyst coating. However, the application of the second support film and removal of the first support film makes this production process very complicated.

EP 1 489 677 A2 relates to a further process for producing a membrane-electrode assembly, in which a first gas diffusion layer is joined with a membrane coated with a catalyst on one side and to a gas diffusion electrode.

It is therefore an object of the present invention to provide a simple and inexpensive production process for catalyst coated membranes or membrane-electrode assemblies for electrochemical devices. In particular, it is an object of the present invention to make continuous production (roll to roll) of catalyst coated membranes or membrane-electrode assemblies possible. A further object of the present invention is, in particular, to avoid swelling of the membrane on application of the liquid catalyst solution.

These objects are achieved according to the invention by a process for producing catalyst coated membranes for electrochemical devices, which comprises the steps:

A) production of a first semifinished product by
application of a first ionomer layer to a first carrier,
application of an anode catalyst layer to the first ionomer layer using a first catalyst ink,
drying of the anode catalyst layer and
removal of the first carrier from the first ionomer layer,

B) production of a second semifinished product by
application of a second ionomer layer to a second carrier,
application of a cathode catalyst layer to the second ionomer layer using a second catalyst ink,
drying of the cathode catalyst layer and
removal of the second carrier from the second ionomer layer and

C) joining of the first semifinished product to the second semifinished product by joining of the first ionomer layer to the second ionomer layer.

The steps A) and B) can be carried out in any order or simultaneously. The removal of the first or second carrier from the first or second ionomer layer can also be carried out in step C) before the first semifinished product is joined to the second semifinished product.

In the present context, an electrochemical device is, for example, a fuel cell, an electrolysis cell or an electrochemical sensor.

In step A), a first semifinished product is produced. The semifinished product is a composite comprising a first ionomer layer and an anode catalyst layer. Here, a first ionomer layer is firstly applied to a first carrier. The ionomer layer preferably comprises cation-conducting polymer materials. A tetrafluoroethylene-fluorovinyl ether copolymer having acid functions, in particular sulfonic acid groups, is usually employed. Such a material is marketed, for example, under the trade name Nafion® by E.I. DuPont. Examples of ionomer materials which can be used for the purposes of the present invention are the following polymer materials and mixtures thereof:
Nafion® (DuPont; USA)
perfluorinated and/or partially fluorinated polymers such as “Dow Experimental Membrane” (Dow Chemicals, USA),
Aciplex-S® (Asahi Chemicals, Japan),
Raipore R-1010 (Pall Rai Manufacturing Co., USA),
Flemion (Asahi Chemicals, Japan),
Raymion® (Chlorine Engineering Corp., Japan).

However, it is also possible to use other, in particular essentially fluorine-free, ionomer materials, for example sulfonated phenol-formaldehyde resins (linear or crosslinked); sulfonated polystyrene (linear or crosslinked); sulfonated poly(2,6-dihphenyl-1,4-phenylene oxides), sulfonated polyaryl ether sulfones, sulfonated polyarylene ether sulfones, sulfonated polyaryl ether ketones, phosphonated poly(2,6-dimethyl-1,4-phenylene oxides), sulfonated polyether ketones, sulfonated polyether ether ketones, aryl ketones or polybenzimidazoles.

In addition, use is made of polymer materials which comprise the following constituents (or mixtures thereof): polybenzimidazolephosphoric acid, sulfonated polyphenylenes, sulfonated polyphenylene sulfide and polymeric sulfonic acids of the type polymer-SO₃X (X═NH₄⁺, NH₃R⁺, NH₂R₂⁺, NHR₃⁺, NR₄⁺).

The first carrier (and also the second carrier in step B)) is preferably a carrier film, in particular a film composed of polyester, polyethylene, polyethylene terephthalate (PET), polytetrafluoroethylene (PTFE), polypropylene (PP), polyvinyl chloride (PVC), polycarbonate, polyamide, polyimide, polyurethane or comparable film materials. The carrier film preferably has a thickness of from 10 to 250 μm, particularly preferably from 90 to 110 μm.

The application of the first ionomer layer to the first carrier is carried out by methods known to those skilled in the art, for example by doctor blade coating, spraying, casting, printing or extrusion processes.

In the process of the invention, the application of the ionomer layer to the carrier is omitted when ionomer membranes which in the form supplied are already joined to a carrier are used.

The first ionomer layer on the first carrier is coated with an anode catalyst layer using a first catalyst ink. The catalyst ink is a solution comprising an electrocatalyst. It comprises, for example, a solvent, one or more electrocatalysts and, if appropriate, further constituents, for example a polyelectrolyte. The catalyst ink, which may, if appropriate, be in the form of a paste, is applied to the first ionomer layer by methods with which those skilled in the art are familiar, for example by printing, spraying, doctor blade coating or rolling, to produce the anode catalyst layer. The catalyst layers applied according to the process of the invention can be applied over all or part of the area. When a catalyst layer is applied to part of the area, the catalyst can be applied, for example, in the form of a geometric pattern.

The anode catalyst layer is subsequently dried. Suitable drying methods are, for example, hot air drying, infrared drying, microwave drying, plasma processes or combinations of these processes.

When the anode catalyst layer has been dried, the first carrier is removed. This is carried out at the latest immediately before joining of the first semifinished product to the second semifinished product. The production of the first semifinished product is thus complete.

In step B) of the process of the invention, a second semifinished product is produced. It is produced in a manner analogous to the production of the first semifinished product. A second ionomer layer and a cathode catalyst layer are applied to a second carrier. The cathode catalyst layer is dried and the carrier is subsequently removed from the second ionomer layer.

The first ionomer layer and the second ionomer layer can each be a single layer or be made up of a plurality of ionomer layers. They can have identical or different thicknesses. The anode catalyst layer and the cathode catalyst layer can each be a single catalyst layer or be made up of a plurality of catalyst layers. The anode catalyst layer and the cathode catalyst layer can have identical or different natures. The two catalyst inks can comprise identical or different electrocatalysts in identical or different proportions. The catalyst layers can each have an area which is identical to or different from the associated ionomer layer.

In step C) of the process of the invention, after the two carriers have been removed from the ionomer layers, the first semifinished product is joined to the second semifinished product by joining the first ionomer layer to the second ionomer layer. Here, the first ionomer layer can be joined directly to the second ionomer layer or be joined indirectly via an intermediate membrane which is laid between the two ionomer layers in the joining step. Such an intermediate membrane can have, for example, a larger area than the two ionomer layers and project beyond the edge of the two ionomer layers after the two semifinished products have been joined. The ionomer margin formed in this way can then be employed for fastening, for example, a frame. If appropriate, this projecting intermediate membrane margin can also be sufficiently thick for a frame to be no longer necessary and a gasket to be fastened, if appropriate, directly to this ionomer margin. The intermediate membrane can consist of a material as has been described above for the ionomer layers.

The direct or indirect joining of the ionomer layers is preferably effected by pressing with application of heat and/or pressure, for example using laminating rollers. Joining can also be effected by means of the methods with which those skilled in the art are familiar, for example by hot pressing, lamination, lamination with additional application of solvent or ultrasonic welding. Joining is preferably effected by pressing with application of heat and/or pressure, for example using laminating rollers. The temperature is in this case preferably from 60° C. to 250° C. and the pressure is preferably from 0.1 to 100 bar. Joining the two semifinished products converts the two ionomer layers into a total ionomer layer which has the anode catalyst layer on one side and the cathode catalyst layer on the other side, i.e. is a catalyst coated membrane.

The process of the invention for producing catalyst coated membranes has, inter alia, the advantage that it can be carried out as a relatively uncomplicated, inexpensive, continuous roll-to-roll process. For this purpose, the carrier with the ionomer layer located thereon is present as a tape on a roll before the two semifinished products are joined to one another. Furthermore, deformation of the ionomer layers, for example as a result of swelling on application of the catalyst ink, is avoided according to the present invention by the ionomer layers being joined to carriers until the catalyst inks have dried. In the process of the invention, the catalyst ink has to be optimized only in respect of wetting of the ionomer layer, so that (for example in contrast to a catalyst coated membrane produced as described in WO 02/39525) good adhesion of the respective catalyst layer to the ionomer layer is achieved.

The catalyst coated membrane produced by the process of the invention is preferably able to be activated subsequently by treatment with acid. The acid extracts the solvent from the membrane (the two ionomer layers which have been joined to one another) and protonates the membrane. Possible acids for subsequent activation of the catalyst coated membrane are, for example, H₂SO₄ or HNO₃.

In a preferred embodiment of the present invention, at least one of the first and second ionomer layers before step C) of the process of the invention is carried out comprises from 0.5 to 35% of a solvent. The ionomer layers comprise, for example a residual solvent such as dimethylacetamide (DMAc) or N-methyl-2-pyrrolidone (NMP), with the residual solvent serving as plasticizer and making the joining of the ionomer layers in step C), for example by means of a lamination process, possible. The ionomer layers can also comprise water as solvent, by means of which a defined water content in the membrane can be set.

In a preferred embodiment of the present invention, a frame is joined to a projecting margin of a semifinished product, a projecting margin of an intermediate membrane, a projecting margin of an ionomer layer or a projecting margin of the membrane.

If the two semifinished products have different areas, a catalyst coated membrane having a projecting margin of a semifinished product is formed by joining of the two semifinished products. The frame can be fastened to this projecting margin of semifinished product.

The first semifinished product can be joined to the second semifinished product either directly or indirectly via an intermediate membrane. When an intermediate membrane is used, a membrane comprising the first and second ionomer layers and an intermediate membrane is formed on joining the two semifinished products. The intermediate membrane can end flush with at least one ionomer layer or form a projecting margin of intermediate membrane. A one-piece or multipart frame can be fastened to this margin of intermediate membrane.

The first ionomer layer and the second ionomer layer can each be covered over all of their area or part of their area with the respective catalyst layer. In the case of partial coverage of one of the ionomer layers and a larger area of this ionomer layer compared to the other ionomer layer, the catalyst coated membrane of the invention can have a projecting margin of ionomer layer. A one-piece or multipart frame can be fastened to this margin of ionomer layer.

If the first and second ionomer layers and any further ionomer layers as previously joined membrane project beyond the two catalyst layers, they form a projecting margin of membrane. A one-piece or multipart frame can be fastened to this margin of membrane.

In a preferred embodiment of the present invention, the first semifinished product and the second semifinished product have different areas so that a projecting margin of the semifinished product remains after the two semifinished products have been joined to form the catalyst coated membrane. The catalyst coated membrane built up in this way can be made more gastight when the marginal region of the catalyst coated membrane has a gasket installed or is sealed. A gasket and/or a reinforcing frame can be fastened to the projecting margin of semifinished product. The projecting margin of semifinished product can run along two or four of the edges of the catalyst coated membrane. To achieve better sealing and to save noble metal, it is advantageous to install a frame on the catalyst coated membrane, in particular an inert plastic frame in the gasket region. In the case of catalyst coated membranes which are produced by conventional processes, a thickened region is always formed by overlap of the membrane or the catalyst coated membrane with the frame, for example when the reinforcing frame is installed between two membrane halves. A thickened region having a thickness which corresponds to the sum of the membrane thickness of the two membrane halves and the thickness of the frame is formed in the overlap region of the membrane halves with the frame. Contacting of the active area is made more difficult by such as thickened region. Lamination according to the invention of two semifinished products of differing size and lamination of a plastic frame onto the projecting margin of the larger semifinished product allows a catalyst coated membrane provided with a frame to be produced without a thickened region. According to a preferred embodiment of the present invention, the projecting margin of semifinished product in the catalyst coated membrane is joined to a frame.

The catalyst coated membrane can, according to the present invention, be joined to a frame which comprises two equal-sized frame halves.

The catalyst coated membrane can, according to the present invention, be joined to a frame which comprises two frame halves of differing size. For example, in the case of two semifinished products of differing size which are joined to one another, a larger frame half can surround the smaller semifinished product and a smaller frame half can surround the larger semifinished product, so that the outer edges of the two frame halves are flush.

The catalyst coated membrane can, according to the present invention, be joined to a frame which is an intermediate frame between two ionomer layer margins projecting beyond the anode and cathode catalyst layers. If the first ionomer layer and the second ionomer layer project beyond the two catalyst layers (coating with catalyst over part of the area), they form projecting margins of ionomer layer. When the two semifinished products are joined, the intermediate frame can be arranged so that it is located at least partly between the two margins of ionomer layer and is thus joined to them. Here, the two ionomer layer margins are given an S-shape, since the ionomer layers of the membrane run outward between the catalyst layers along one of the two sides of the intermediate frame.

The frame of a catalyst coated membrane produced by the process of the invention can comprise any nonfunctionalized, gastight polymer, in particular polyether sulfones, polyamide, polyimide, polyether ketone, polysulfone, polytetrafluoroethylene (PTFE), polyvinylidene fluoride (PVDF), polyethylene (PE) or polypropylene (PP). The frame or the frame halves can, according to the present invention, be present as a tape on a roll before being fastened to the catalyst coated membrane, so that a roll-to-roll process makes a high throughput possible. The frame can be provided with an adhesive layer.

In a preferred embodiment of the present invention, at least one of the anode or cathode catalyst layers is joined to a gas diffusion layer. The gas diffusion layer can serve as mechanical support for the electrode and ensures good distribution of the respective gas over the catalyst layer and allows the electrons to be conducted away. A gas diffusion layer is required particularly for fuel cells which are operated using hydrogen as fuel and oxygen or air as oxidant.

According to the present invention, preference is given to the anode catalyst layer being joined to a first gas diffusion layer and the cathode catalyst layer being joined to a second gas diffusion layer so that the first gas diffusion layer and the anode catalyst layer and also the second gas diffusion layer and the cathode catalyst layer are in each case flush with one another at the edges. Thus, for example, if the anode catalyst layer and the cathode catalyst layer have different areas, the second gas diffusion layers likewise have these different areas and are flush with the respective catalyst layer on all sides in this embodiment. However, it is also possible for the anode catalyst layer to be joined to a first gas diffusion layer and the cathode catalyst layer to be joined to a second gas diffusion layer so that at least one of the first and second gas diffusion layers has a margin which projects beyond the anode or cathode catalyst layer. If, for example, the two semifinished products (including the respective catalyst layer) have different areas, the two gas diffusion layers can nevertheless have equal areas which correspond to the larger area of the semifinished products, in which case one of the gas diffusion layers then has a margin which projects beyond the edge of the smaller semifinished product. The margin of the gas diffusion layer can then overlap a frame.

In a preferred embodiment of the present invention, the catalyst coated membrane is joined to a frame and on each side to a gas diffusion layer, in addition, a gasket is installed on at least one transition region between catalyst coated membrane or the frame and a gas diffusion layer. For example all edges of the gas diffusion layer are comprised by a suitable gasket material. Suitable gasket materials are, for example, silicones, polyisobutylene (PIB), rubbers (synthetic and natural), fluoroelastomers and fluorosilicones.

A preferred embodiment of the present invention provides for at least one of the ionomer layers to comprise at least one additional constituent selected from the group consisting of blend components, reinforcing fabrics, microporous support films and fillers. As blend components, it is possible to use nonfunctionalized polymers which improve the mechanical properties of the ionomer layer, for example polyether sulfones, polysulfones, polybenzimidazole (PBI) or polyimides. The reinforcing fabric can, for example, be a fine polymer or fiberglass fabric around which functionalized polymer is poured. Suitable microporous support films are known, for example, from U.S. Pat. No. 5,635,041. As an alternative, microporous membranes into which a functionalized polymer is poured are conceivable. Fillers serve, for example, to store water and/or improve the mechanical stability of the ionomer layer. As fillers, it is possible to use, for example, silicon dioxide, zirconium phosphates, zirconium phosphonates or heteropolyacids. According to a preferred embodiment of the present invention, the filler is a catalyst, in particular a catalyst which can be composed of peroxides or H₂O₂ and/or can prevent the formation of peroxides and/or can convert H₂ and O₂ into H₂O and/or can react alcohols. Examples are noble metal nanoparticles or noble metal particles immobilized on carbon black.

A preferred embodiment of the present invention provides for at least one additional layer comprising an additive selected from the group consisting of solvents, solutions of a polyelectrolyte, dispersions of a polyelectrolyte, fillers and catalysts to be applied between the two semifinished products (before step C) of the process of the invention). The additive forms an intermediate layer in the overall ionomer layer (membrane) of the catalyst coated membrane. This intermediate layer can take on various functions (for example, can serve as bonding agent).

A solvent (for example dimethylacetamide (DMAc), N-methyl-2-pyrrolidone (NMP) or dimethyl sulfoxide (DMSO)) can partially dissolve the membrane (depending on the membrane used). A solvent such as water can, for example, lower the glass transition temperature.

Polyelectrolytes are functionalized membrane polymers (ionomers) which can be used as additive. These can, for example, be selected from among the possible ionomers which have been listed above for the two ionomer layers, for example from among Nafion® from DuPont, Flemion® from Asahi Chemicals or Fumion® from Fumatech.

Fillers which can be used as additive are, for example, inorganic materials such as silicates or sheet silicates which serve as barrier layer (for example for methanol).

Catalysts which can be used as additive are, for example, elements of the platinum group which allow the diffusing hydrogen and oxygen to recombine to form water and thus moisten the membrane internally and at the same time stop the respective gas from getting to the other electrode.

In a preferred embodiment of the present invention, the first semifinished product is joined to the second semifinished product in step C) of the process of the invention, with the first and second semifinished products having different degrees of sulfonation of their ionomer layers.

The degree of sulfonation (number of functional groups) determines various properties of the membrane. The (undesirable) swelling of the membrane increases with increasing degree of sulfonation. The ionic conductivity of the membrane, which should be as high as possible, increases with the degree of sulfonation. Furthermore, the permeability to gases (or in the case of a direct methanol fuel cell (DMFC), the permeability to methanol), which should be as low as possible, increases with increasing degree of sulfonation. The joining of ionomer layers having differing degrees of sulfonation allows positive property combinations to be achieved. For example, a thin ionomer layer having a low degree of sulfonation so as to reduce the swelling and permeability can be joined to a thick ionomer layer having a high degree of sulfonation to give a good conductivity to form a membrane. Since the degree of sulfonation also has a positive influence on the water uptake of the membrane, the water balance of the membrane can also be influenced positively by the different degrees of sulfonation of the ionomer layers.

In particular, a relatively high degree of sulfonation of the first ionomer layer on the anode side, through which water is transported to the anode, is advantageous.

The invention further provides a process for producing a membrane-electrode assembly for electrochemical devices, which comprises the steps
a) application of a first ionomer layer to a carrier, application of a catalyst layer to the first ionomer layer using a catalyst ink, drying of the catalyst layer and removal of the carrier and
b) joining of the first ionomer layer to a gas diffusion electrode to form a membrane-electrode assembly.

In a particularly preferred embodiment of the present invention, the gas diffusion electrode has a second ionomer layer before the joining in step b). The process of the invention for producing a membrane-electrode assembly for electrochemical devices then comprises the steps:
i) application of a first ionomer layer to a carrier, application of a catalyst layer to the first ionomer layer using a catalyst ink, drying of the catalyst layer and removal of the carrier,
ii) application of a second ionomer layer to a gas diffusion electrode and
iii) joining of the first ionomer layer to the second ionomer layer to form a membrane-electrode assembly.

The application of the first ionomer layer to the carrier in step a) or i) is carried out by methods known to those skilled in the art, for example by doctor blade coating, spraying, casting, printing or extrusion processes.

In the process of the invention, the application of the ionomer layer to the carrier is omitted when ionomer membranes which in the form supplied are already joined to a carrier are used.

The first ionomer layer on the first carrier is coated with a catalyst layer using a first catalyst ink. The catalyst ink is a solution comprising an electrocatalyst. It comprises, for example, a solvent, one or more electrocatalysts and, if appropriate, further constituents, for example a polyelectrolyte. The catalyst ink, which may, if appropriate, be in the form of a paste, is applied to the first ionomer layer by methods with which those skilled in the art are familiar, for example by printing, spraying, doctor blade coating or rolling, to produce the catalyst layer. The catalyst layer applied according to the process of the invention can be applied over all or part of the area. When a catalyst layer is applied to part of the area, the catalyst can be applied, for example, in the form of a geometric pattern.

The catalyst layer is subsequently dried. Suitable drying methods are, for example, hot air drying, infrared drying, microwave drying, plasma processes or combinations of these processes.

When the catalyst layer has been dried and before the first semifinished product is joined to the second semifinished product, the first carrier is removed. The production of a first semifinished product is thus complete.

If appropriate, a second ionomer layer is then applied to a gas diffusion electrode (step ii)). This is carried out by methods with which those skilled in the art are familiar.

The gas diffusion electrode comprises at least one gas diffusion layer and a catalyst layer. If appropriate, the gas diffusion electrode additionally comprises a further layer between the gas diffusion layer and the catalyst layer, in particular a microporous layer (e.g. comprising carbon black and a hydrophobic binder (e.g. PTFE)) which serves to control the water balance.

In a further step b) or iii), the first ionomer layer is joined to (if appropriate a second ionomer layer of) the gas diffusion electrode to form a membrane-electrode assembly. Joining can also be effected by means of the methods with which those skilled in the art are familiar, for example by hot pressing, lamination, lamination with additional application of solvent or ultrasonic welding. Joining is preferably effected by pressing with application of heat and/or pressure, for example using laminating rollers. The temperature is in this case preferably from 60° C. to 250° C. and the pressure is preferably from 0.1 to 100 bar.

The membrane-electrode assembly which has been produced in this way is supplemented by application of a further gas diffusion layer to the catalyst layer produced in step a) or i).

The invention further provides a catalyst coated membrane for electrochemical devices, which comprises two semifinished products joined to one another, namely a first semifinished product comprising a first ionomer layer joined to an anode catalyst layer and a second semifinished product comprising a second ionomer layer joined to a cathode catalyst layer, with a frame being joined to a projecting margin of a semifinished product, a projecting margin of an intermediate membrane, a projecting margin of an ionomer layer or a projecting margin of the membrane or is arranged as intermediate frame between two margins of ionomer layers.

The catalyst coated membrane of the invention can be produced by the process of the invention for producing catalyst coated membranes.

In particular, the invention provides a catalyst coated membrane for electrochemical devices, which comprises two semifinished products joined to one another, namely a first semifinished product comprising a first ionomer layer joined to an anode catalyst layer and a second semifinished product comprising a second ionomer layer joined to a cathode catalyst layer, with the two semifinished products having different areas.

The advantages of different areas of the semifinished products have been explained above. Better sealing and thickening-free framing of the catalyst coated membrane, inter alia, can be achieved.

If the two semifinished products have different areas, a catalyst coated membrane having a projecting margin of a semifinished product is formed by joining of the two semifinished products. The frame can be fastened to this projecting margin of semifinished product.

The first semifinished product can be joined to the second semifinished product either directly or indirectly via an intermediate membrane. One embodiment of an inventive catalyst coated membrane therefore comprises a membrane comprising the first and second ionomer layers and an intermediate membrane. The intermediate membrane can end flush with at least one ionomer layer or form a projecting margin of intermediate membrane. A one-piece or multipart frame can be fastened to this margin of intermediate membrane. However, the intermediate membrane can also be made sufficiently thick for no additional frame being necessary to support the catalyst coated membrane of the invention. A gasket can then be installed directly on the projecting margin of the intermediate membrane.

The first ionomer layer and the second ionomer layer of the catalyst coated membrane of the invention can each be covered over all of their area or part of their area with the respective catalyst layer. In the case of partial coverage of one of the ionomer layers and a larger area of this ionomer layer compared to the other ionomer layer, the catalyst coated membrane of the invention can have a projecting margin of ionomer layer. A one-piece or multipart frame can be fastened to this margin of ionomer layer.

If the first and second ionomer layers and any further ionomer layers as previously joined membrane project beyond the two catalyst layers, they form a projecting margin of membrane. A one-piece or multipart frame can be fastened to this margin of membrane.

If the first ionomer layer and the second ionomer layer project beyond the two catalyst layers (coating with catalyst over part of the area), they form projecting margins of ionomer layer. When the two semifinished products are joined, the intermediate frame can be arranged so that it is located at least partly between the two margins of ionomer layer and is thus joined to them. Here, the two ionomer layer margins are given an S-shape, since the ionomer layers of the membrane run outward between the catalyst layers along one of the two sides of the intermediate frame.

Furthermore, the invention provides a fuel cell comprising at least one catalyst coated membrane according to the invention.

The invention is described in more detail below with reference to the drawing.

In the drawing:

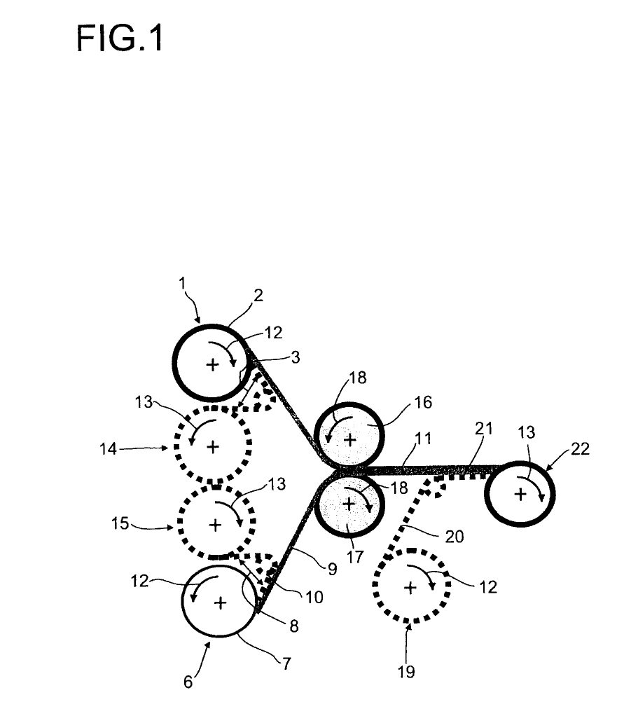

FIG. 1 schematically shows a process according to the invention for producing catalyst coated membranes without a frame,

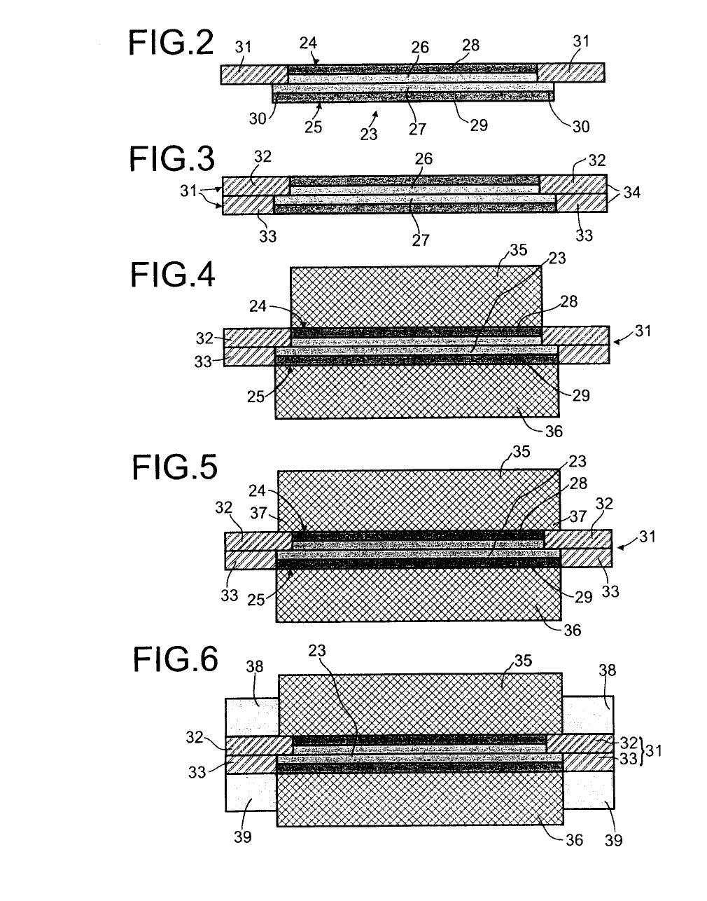

FIG. 2 shows a catalyst coated membrane according to the invention having a frame,

FIG. 3 shows a further catalyst coated membrane according to the invention having a frame made up of two frame halves of differing size,

FIG. 4 shows a further catalyst coated membrane according to the invention having a frame and different-sized gas diffusion layers which end flush with the respective catalyst layer,

FIG. 5 shows a further catalyst coated membrane according to the invention having a frame and equal-sized gas diffusion layers,

FIG. 6 shows a further catalyst coated membrane according to the invention having a frame, gas diffusion layers and gasket,

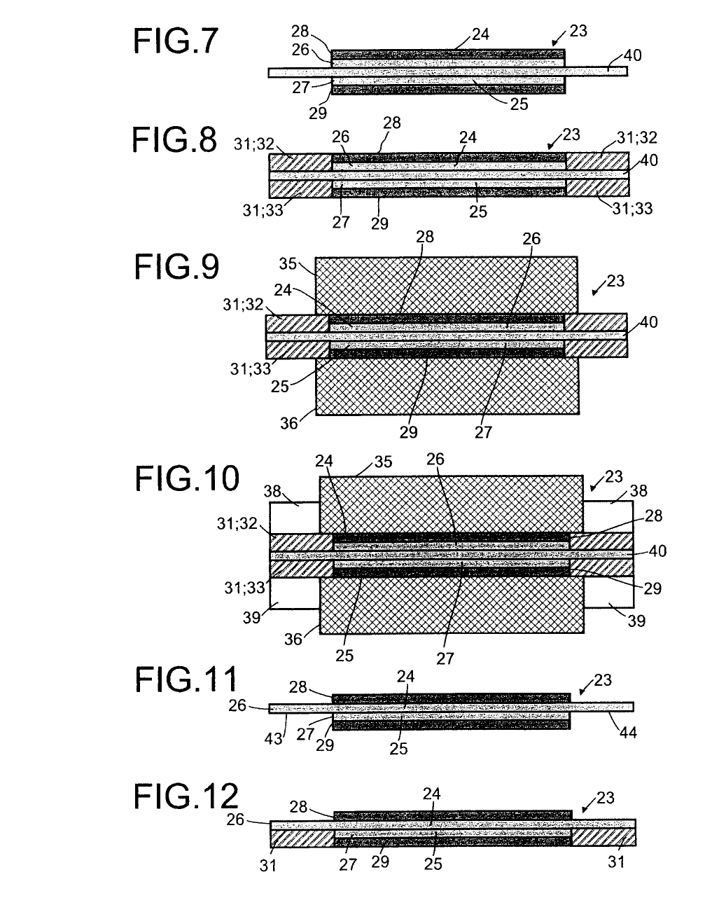

FIG. 7 shows a further catalyst coated membrane according to the invention having an intermediate membrane,

FIG. 8 shows a further catalyst coated membrane according to the invention having an intermediate membrane and a frame,

FIG. 9 shows a further catalyst coated membrane according to the invention having an intermediate membrane, a frame and gas diffusion layers,

FIG. 10 shows a further catalyst coated membrane according to the invention having an intermediate membrane, frame, gas diffusion layers and gasket,

FIG. 11 shows a further catalyst coated membrane according to the invention having a catalyst layer applied over only part of the area on one side,

FIG. 12 shows a further catalyst coated membrane according to the invention as shown in FIG. 11 but with frame,

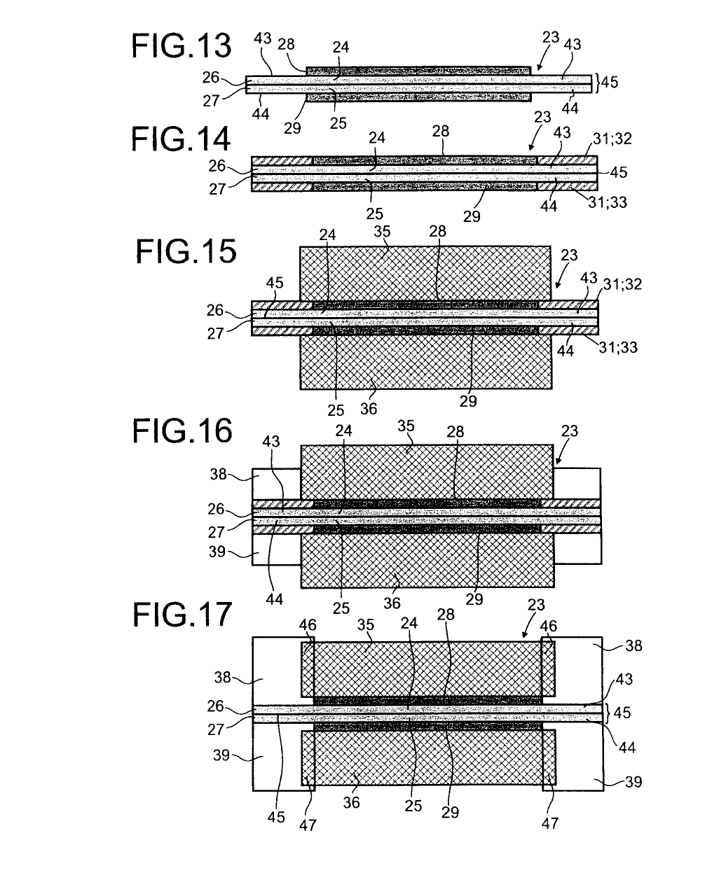

FIG. 13 shows a further catalyst coated membrane according to the invention comprising two semifinished products having a catalyst layer applied over part of the area,

FIG. 14 shows a further catalyst coated membrane according to the invention as shown in FIG. 13 but with a frame,

FIG. 15 shows a further catalyst coated membrane according to the invention as shown in FIG. 14 with gas diffusion layers,

FIG. 16 shows a further catalyst coated membrane according to the invention as shown in FIG. 15 with a gasket,

FIG. 17 shows a further catalyst coated membrane according to the invention having catalyst layers applied over part of the area, gas diffusion layers and gasket,

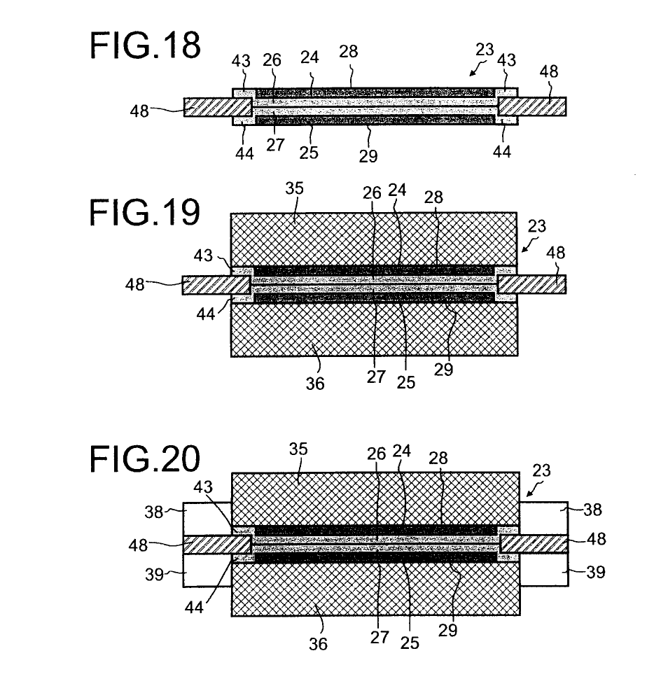

FIG. 18 shows a further catalyst coated membrane according to the invention having catalyst layers applied over part of the area and a frame fastened between the ionomer layers,

FIG. 19 shows a catalyst coated membrane according to the invention as shown in FIG. 18 with gas diffusion layers,

FIG. 20 shows a further catalyst coated membrane according to the invention as shown in FIG. 19 with a gasket,

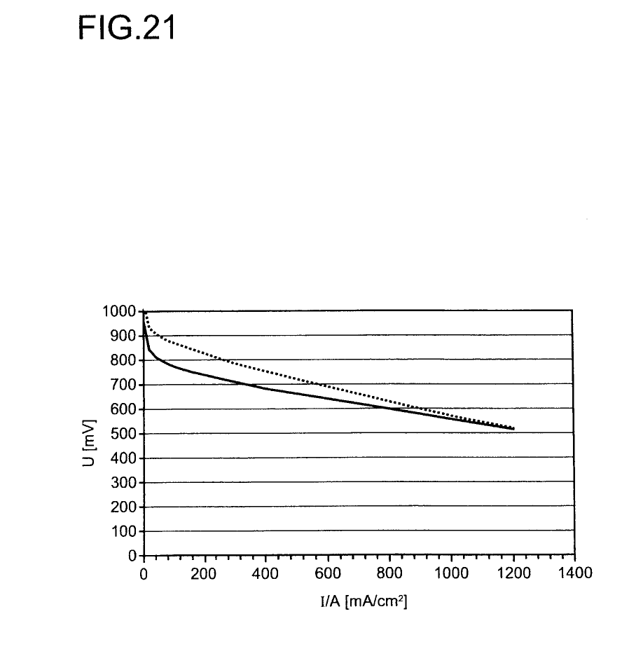

FIG. 21 shows the current-voltage curves for a first example according to the invention and a first comparative example and

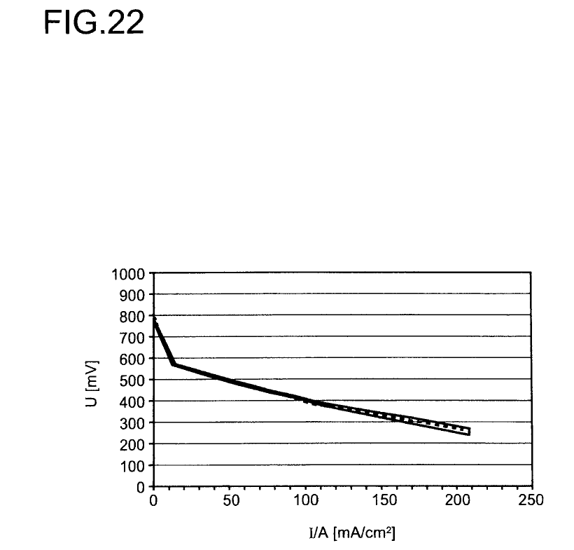

FIG. 22 shows the current-voltage curves for a second example according to the invention and a second comparative example.

FIG. 1 schematically shows the production of catalyst coated membranes having a frame by a process according to the invention.

The process depicted is a roll-to-roll process which makes a high throughput and inexpensive production possible. A first roll 1 comprises a first semifinished product 2 on a first carrier 3. The first semifinished product 2 comprises a first ionomer layer 4 and an anode catalyst layer 5. The first ionomer layer 4 is joined to the anode catalyst layer 5. A second roll 6 comprises a second semifinished product 7 on a second carrier 8. The second semifinished product 7 comprises a second ionomer layer 9 and a cathode catalyst layer 10. The second ionomer layer 9 is joined to the cathode catalyst layer 10. The cathode catalyst layer 10 can have been applied either over the entire area or over part of the area, e.g. in the form of a regular geometric pattern.

In the production of the catalyst coated membrane 11 according to the invention, the first and second rolls 1, 6 are rotated in the unrolling direction 12. The first and second carriers 3, 8 are removed from the first and second ionomer layers 4, 9 and rolled up on first and second carrier rolls 14 and 15, respectively, rotating in the rolling-up direction 13. The first semifinished product 2 is then joined to the second semifinished product 7 by joining the first ionomer layer 4 to the second ionomer layer 9. This is affected under the action of pressure and temperature with the aid of two laminating rollers 16, 17 which rotate in the roller direction 18.

The catalyst coated membrane 11 produced in this way is subsequently provided with a support film. This is a support film 20 which is made available on the film roll 19 and is joined to the catalyst coated membrane 11. The supported catalyst coated membrane 21 produced in this way is rolled up on a stock roll 22. Pieces can then be taken off from the stock roll 22 as required and be provided with frames, and these can then be used as framed catalyst coated membranes in electrochemical devices, in particular in polymer electrolyte membrane fuel cells.

FIG. 2 shows a catalyst coated membrane according to the invention having a frame.

The catalyst coated membrane 23 depicted in FIG. 2 has preferably been produced by the process of the invention. It comprises two semifinished products 24, 25 which each have an ionomer layer 26 or 27 and an anode or cathode catalyst layer 28 or 29. The anode catalyst layer 28 ends flush with the first ionomer layer 26 and the cathode catalyst layer 29 ends flush with the second ionomer layer 27. The first semifinished product 24 and the second semifinished product 25 have different areas, so that the catalyst coated membrane 23 produced from the two semifinished products 24, 25 has a projecting margin 30 of semifinished product. A frame 31 is fastened to the projecting margin 30 of the one semifinished product.

FIG. 3 shows a further catalyst coated membrane having a frame made up of two frame halves having different sizes.

The catalyst coated membrane depicted in FIG. 3 corresponds largely to that depicted in FIG. 2, except that it is joined to a frame 31 which comprises two frame halves, 32, 33 of different sizes. The first frame half has a larger area and surrounds the smaller first semifinished product 24 and the second frame half 33 has a smaller area and surrounds the larger second semifinished product 25. The outer edges 34 of the frame halves 32, 33 are flush.

FIG. 4 shows a further catalyst coated membrane according to the invention having a frame and different-sized gas diffusion layers.

The catalyst coated membrane 23 depicted in FIG. 4 has a structure which corresponds largely to that in FIG. 3; in particular, the frame 31 is composed of two frame halves 32, 33. Two different-sized gas diffusion layers 35, 36 are joined to the catalyst coated membrane 23. Here, the area of the respective gas diffusion layer 35 or 36 corresponds to the area of the associated semifinished product 24 or 25. The first gas diffusion layer 35 thus ends flush with the anode catalyst layer 28 and the second gas diffusion layer 36 ends flush with the cathode catalyst layer 29.

FIG. 5 shows a further catalyst coated membrane according to the invention having a frame and equal-sized gas diffusion layers.

The catalyst coated membrane 23 depicted in FIG. 5 has a structure which largely corresponds to that in FIG. 3; in particular, the frame 31 is composed of two frame halves 32, 33. Two equal-sized gas diffusion layers 35, 36 are joined to the catalyst coated membrane 23. Here, the area of each of the two gas diffusion layers 35, 36 corresponds to the area of the second semifinished product 25. The second gas diffusion layer 36 thus ends flush with the cathode catalyst layer 29. The first gas diffusion layer 35 has a margin 37 which projects beyond the (smaller-area) anode catalyst layer 28. The margin 37 of the gas diffusion layer thus overlaps part of the first frame half 32.

FIG. 6 shows a further catalyst coated membrane having a frame, gas diffusion layers and gaskets.

The structure of the catalyst coated membrane 23 according to the invention having a frame 31 and gas diffusion layers 35, 36 which is depicted in FIG. 6 corresponds largely to the structure of the embodiment depicted in FIG. 5. In addition, a gasket 38, 39 is in each case installed in a transition region between the first frame half 32 and the first gas diffusion layer 35 and between the second frame half 33 and the second gas diffusion layer 36.

FIG. 7 shows a further catalyst coated membrane according to the invention having two catalyst layers applied over the entire area of the ionomer layers and an intermediate membrane.

The catalyst coated membrane 23 depicted in FIG. 7 comprises two semifinished products 24, 25 which each have an ionomer layer 26 or 27 and an anode or cathode catalyst layer 28 or 29 applied over the entire area thereof. The anode catalyst layer 28 ends flush with the first ionomer layer 26 and the cathode catalyst layer 29 ends flush with the second ionomer layer 27. The first semifinished product 24 and the second semifinished product 25 have equal areas. Between the first ionomer layer 26 and the second ionomer layer 27, there is an intermediate membrane 40 which has a larger area than each of the two semifinished products 24, 25. As a result, the intermediate membrane 40 projects over the edge of the two semifinished products 24, 25 in the catalyst coated membrane 23 and forms a margin 41 of intermediate membrane.

FIG. 8 shows a further catalyst coated membrane according to the invention having a frame made up of two frame halves.

The catalyst coated membrane 23 depicted in FIG. 8 corresponds largely to that depicted in FIG. 7, except that it is joined to a frame 31 which comprises two equal-sized frame halves 32, 33. The two frame halves 32, 33 are fastened to the margin 41 of the intermediate membrane. The outer edges 34 of the frame halves 32, 33 are flush.

FIG. 9 shows a further catalyst coated membrane according to the invention having a frame and gas diffusion layers.

The catalyst coated membrane 23 depicted in FIG. 9 has a structure which largely corresponds to that in FIG. 8, with two gas diffusion layers 35, 36 being joined to the catalyst coated membrane 23. The area of the gas diffusion layers 35, 36 is greater than the area of the two semifinished products 24, 25 and partly overlaps the frame halves 32, 33. The two gas diffusion layers 35, 36 have the same size.

FIG. 10 shows a further catalyst coated membrane according to the invention having an intermediate membrane, a frame, gas diffusion layers and gaskets.

The structure of the catalyst coated membrane 23 according to the invention depicted in FIG. 10 having an intermediate membrane 40, a frame 31 and gas diffusion layers 35, 36 corresponds largely to the structure of the embodiment depicted in FIG. 9. In addition, a gasket 38, 39 is in each case installed in a transition region between the first frame half 32 and the first gas diffusion layer 35 and between the second frame half 33 and the second gas diffusion layer 36.

FIG. 11 shows a further catalyst coated membrane according to the invention having a catalyst layer applied over the entire area and a catalyst layer applied over part of the area.

The catalyst coated membrane 23 depicted in FIG. 11 comprises two semifinished products 24, 25 which each have an ionomer layer 26 or 27 and an anode or cathode catalyst layer 28 or 29. The cathode catalyst layer 29 is applied over the entire area of the second ionomer layer 27 and ends flush with this. The anode catalyst layer 28 is applied over part of the area of the first ionomer layer 26, so that a margin 42 of ionomer layer projects beyond the anode catalyst layer 28. Since the two catalyst layers 28, 29 have the same area, the margin 42 of the one ionomer layer also projects beyond the catalyst coated membrane 23.

FIG. 12 shows a further catalyst coated membrane according to the invention having a one-part frame.

The catalyst coated membrane depicted in FIG. 12 corresponds largely to that depicted in FIG. 11, except that it is joined to a one-piece frame 31. The frame 31 is fastened to the projecting margin 42 of the one ionomer layer. It ends flush with the margin 42 of the ionomer layer.

FIG. 13 shows a further catalyst coated membrane according to the invention having anode and cathode layers applied over part of the area.

The catalyst coated membrane 23 depicted in FIG. 13 comprises two semifinished products 24, 25 which each have an ionomer layer 26 or 27 and an anode or cathode catalyst layer 28 or 29. The two catalyst layers 28, 29 are applied to only part of the area of the ionomer layers 26, 27, so that a margin 43, 44 of each of the ionomer layers 26, 27 projects beyond the catalyst layers 28, 29. In the catalyst coated membrane 23, these two margins 43, 44 of an ionomer layer form a membrane margin 45 projecting beyond the two equal-sized catalyst layers 28, 29.

FIG. 14 shows a further catalyst coated membrane according to the invention having a frame made up of two frame halves which is fastened to a margin of the membrane.

The catalyst coated membrane depicted in FIG. 14 has a structure which largely corresponds to that in FIG. 13, with a frame 31 fastened to the margin 45 of the membrane being additionally present. The frame 31 comprises two equal-sized frame halves 32, 33 which end flush with the margin 45 of the membrane. In the production of this catalyst coated membrane 23 according to the invention, the two frame halves 32, 33 can either be joined to the margin 45 of the membrane after the two semifinished products 24, 25 have been joined or each of the frame halves 32, 33 can be joined to an ionomer layer 26, 27 after this ionomer layer 26, 27 has been applied to the respective carrier and before the respective catalyst layer 28, 29 is applied to the ionomer layer 26, 27.

In a roll-to-roll process according to the invention, in which the catalyst layers are applied to the ionomer layers after application of the frame to produce the respective semifinished product, it is possible, for example, for an ionomer layer firstly to be applied to the respective carrier film, a frame film then to be joined to the ionomer layer and the respective catalyst layer then to be applied, e.g. by doctor blade application or printing of the catalyst ink, to the ionomer layer in the window formed by the frame film.

FIG. 15 shows a further catalyst coated membrane having a frame and gas diffusion layers.

The catalyst coated membrane 23 depicted in FIG. 15 has a structure which corresponds largely to that in FIG. 14, with two gas diffusion layers 35, 36 being additionally joined to the catalyst coated membrane 23. The gas diffusion layers 35, 36 have a larger area than the catalyst layers 28, 29 and partly overlap the two frame halves 32, 33.

FIG. 16 shows a further catalyst coated membrane according to the invention having a frame, gas diffusion layers and gaskets.

The structure of the catalyst coated membrane 23 having a frame 31 and gas diffusion layers 35, 36 which is depicted in FIG. 16 corresponds largely to the structure of the embodiment depicted in FIG. 15. In addition, a gasket 38, 39 is in each case installed in a transition region between the first frame half 32 and the first gas diffusion layer 35 and between the second frame half 33 and the second gas diffusion layer 36.

FIG. 17 shows a further catalyst coated membrane according to the invention having gas diffusion layers and gaskets.

The catalyst coated membrane 23 depicted in FIG. 17 has, in addition to the structure depicted in FIG. 13, two gas diffusion layers 35, 36 which each project beyond the adjoining catalyst layer 28, 29 and form projecting margins 46, 47 of gas diffusion layer. These margins 46, 47 of gas diffusion layer have, together with the membrane margin 45 which projects out even further, gaskets 38, 39 sprayed around them. The gaskets 38, 39 end flush with the membrane margin 45.

FIG. 18 shows a further catalyst coated membrane according to the invention having catalyst layers applied to part of the area and a frame fastened between margins of ionomer layers.

The catalyst coated membrane 23 depicted in FIG. 18 comprises two semifinished products 24, 25 each having an ionomer layer 26 or 27 and an anode or cathode catalyst layer 28 or 29. The two ionomer layers 26, 27 are coated with the catalyst layers 28, 29 over only part of their area, so that they form a margin 43 of the first ionomer layer and a margin 44 of the second ionomer layer, which margins project beyond the catalyst layers 28, 29. A one-part intermediate frame 48 is fastened between these two margins 43, 44 of ionomer layers. The intermediate frame 48 projects beyond the two margins 43, 44 of the ionomer layers. This preferred embodiment of the catalyst coated membrane 23 of the invention makes a thickening-free incorporation of the frame possible.

FIG. 19 shows a further catalyst coated membrane according to the invention having a frame and gas diffusion layers.

The catalyst coated membrane 23 depicted in FIG. 19 has a structure which largely corresponds to that in FIG. 18, but additionally has two gas diffusion layers 35, 36 joined to the catalyst coated membrane 23. The gas diffusion layers 35, 36 each end flush with the margins 43, 44 of the two ionomer layers.

FIG. 20 shows a further catalyst coated membrane according to the invention having an intermediate frame, gas diffusion layers and gaskets.

The structure of the catalyst coated membrane 23 according to the invention having an intermediate frame 48 and gas diffusion layers 35, 36 which is depicted in FIG. 20 largely corresponds to the structure of the embodiment depicted in FIG. 19. In addition, a gasket 38, 39 is in each case installed in a transition region between the intermediate frame 48 and the gas diffusion layers 35, 36.

FIG. 21 shows the current-voltage curves for a first example according to the invention and for a first comparative example.

The voltage U in mV is plotted on the Y axis and the current density I/A in mA/cm² is plotted on the X axis. The continuous line corresponds to the example according to the invention and the broken line corresponds to the comparative example. The examples are described in detail below.

### Example 1

Two membranes of the type GK1065-049d (blend membrane comprising sPEEK and Ultrason E; not hydrated) having a residual solvent content of >22% of NMP and a dry layer thickness of 22 μm, each located on a 100 μm thick PET film provided as carrier, are sprayed on one side with a catalyst ink comprising a catalyst comprising about 50% of Pt supported on carbon black and Nation® ionomer solution (EW1100 5%, Sigma Aldrich) to produce an anode-side semifinished product and a cathode-side semifinished product having Pt loadings of about 0.15 mg/cm² and 0.4 mg/cm², respectively. The carrier is removed. The halves are joined between two cardboard sheets on a film lamination machine (Ibico IL 12 HR) at a roller temperature of 120° C. and the speed setting 2 to form a catalyst coated membrane. The composite is subsequently treated in 1N H₂SO₄ at 80° C. for 2 hours and then thoroughly washed with deionized water at room temperature. The catalyst coated membrane obtained in this way is pressed together with two gas diffusion layers (SGL Carbon, 21 BC) at 90° C. and a force of 20 kN for 10 minutes to form a membrane-electrode assembly (MEA) having an active area of 32.5 cm². The MEA obtained in this way is operated in a 25 cm² test cell, for example from Electro Chem, at 75° C., 1 bar, 100% relative humidity using H₂ (λ=1.5) and O₂ (λ=2). The current-voltage curve measured is shown as a continuous line in FIG. 21. The high-frequency resistance of the system determined by means of impedance spectroscopy is 2.8 mΩ.

### Comparative Example 1

A membrane of the type GK1065-049b (blend membrane comprising sPEEK and Ultrason E; hydrated in 1M H₂SO₄ at 80° C. for 2 hours) having a dry layer thickness of 43 μm and a residual solvent content of <0.5% of NMP is sprayed on both sides with a catalyst ink comprising a catalyst comprising about 50% of Pt supported on carbon black and Nation® ionomer solution (EW 1100 5%, Sigma Aldrich) to produce an anode-side Pt loading of 0.15 mg/cm² and a cathode-side Pt loading of 0.4 mg/cm². The catalyst coated membrane obtained in this way is pressed together with two gas diffusion layers (SGL Carbon, 21 BC) at 90° C. and a force of 20 kN for 10 minutes to form a membrane-electrode assembly (MEA) having an active area of 32.5 cm². The MEA obtained in this way is operated in a 25 cm² test cell, for example from Elektro Chem, at 75° C., 1 bar, 100% relative humidity using H₂ (μ=1.5) and O₂ (λ=2). The current-voltage curve is likewise shown in FIG. 21, this time as a broken line. The high-frequency resistance of the system determined by means of impedance spectroscopy is 3 mΩ.

FIG. 22 shows the current-voltage curves for a second example according to the invention and for a second comparative example.

The voltage U in mV is plotted on the Y axis and the current density I/A in mA/cm² is plotted on the X axis. The continuous line corresponds to the example according to the invention and the broken line corresponds to the comparative example. The examples are described in detail below.

### Example 2

A membrane of the type GK1130-051 (blend membrane comprising sPEEK and Ultrason E; not hydrated) having a residual solvent content of >22% of NMP and a dry layer thickness of 35 μm is sprayed on one side with a catalyst ink comprising a catalyst comprising about 70% of Pt supported on carbon black and Nafion™ ionomer solution (EW 1100 10%, Sigma Aldrich) to produce a cathode-side semifinished product having a Pt loading of about 2 mg/cm².

A membrane of the same type is sprayed on one side with a catalyst ink comprising a catalyst comprising about 80% of PtRu supported on carbon black and sPEEK ionomer solution to produce an anode-side semifinished product having a PtRu loading of about 3 mg/cm².

The semifinished products are joined between 2 PET films on a film lamination machine (Ibico IL 12 HR) at a roller temperature of about 130° C. and the speed setting 1 to form a CCM. The composite is subsequently treated in 1N HNO₃ at 60° C. for 2 hours and then washed thoroughly with deionized water at room temperature. The CCM obtained in this way is dried and operated in combination with 2 juxtaposed gas diffusion layers in a test cell having a cell area of 25 cm² at 70° C., 1 bar, using 3.2% methanol solution and dry air (λ=3). The current-voltage curve measured is shown in FIG. 22 (continuous line). The high-frequency resistance of the system determined by means of the impedance spectroscopy is 12.2 mΩ.

### Comparative Example 2

A membrane of the type GK1065-53 (blend membrane comprising sPEEK and Ultrason E; hydrated in 1M H₂SO₄ at 80° C. for 2 hours) having a dry layer thickness of 61 μm and a residual solvent content of <0.5% of NMP is sprayed with a catalyst ink comprising a catalyst comprising about 70% of Pt supported on carbon black and Nafion™ ionomer solution (EW 1100 10%, Sigma Aldrich) to produce a cation-side Pt loading of 2 mg/cm² and sprayed with a catalyst ink comprising a catalyst comprising about 80% of PtRu supported on carbon black and sPEEK ionomer solution to produce an anode-side PtRu loading of 3 mg/cm².

The catalyst coated membrane obtained in this way is dried and operated in combination with 2 juxtaposed gas diffusion layers in a test cell having a cell area of 25 cm² at 70° C., 1 bar, using 3.2% methanol solution and dry air (λ=3). The current-voltage curve is likewise shown in FIG. 22 (broken line). The high-frequency resistance of this system determined by means of impedance spectroscopy is 10.6 mΩ.

### LIST OF REFERENCE NUMERALS

1 first roll

2 first semifinished product

3 first carrier

4 first ionomer layer

5 anode catalyst layer

6 second roll

7 second semifinished product

8 second carrier

9 second ionomer layer

10 cathode catalyst layer

11 catalyst coated membrane

12 unrolling direction

13 rolling-up direction

14 first carrier roll

15 second carrier roll

16 first laminating roller

17 second laminating roller

18 roller direction

19 film roll

20 support film

21 supported catalyst coated membrane

22 stock roll

23 catalyst coated membrane

24 first semifinished product

25 second semifinished product

26 first ionomer layer

27 second ionomer layer

28 anode catalyst layer

29 cathode catalyst layer

30 projecting margin of semifinished product

31 frame

32 first frame half

33 second frame half

34 outer edges

35 first gas diffusion layer

36 second gas diffusion layer

37 margin of gas diffusion layer

38 first gasket

39 second gasket

40 intermediate membrane

41 margin of intermediate membrane

42 margin of ionomer layer

43 margin of first ionomer layer

44 margin of second ionomer layer

45 margin of membrane

46 margin of first gas diffusion layer

47 margin of second gas diffusion layer

48 intermediate frame

1. A process for producing catalyst coated membranes for electrochemical devices, which comprises
A) production of a first semifinished product by
application of a first ionomer layer to a first carrier,
application of an anode catalyst layer to the first ionomer layer using a first catalyst ink,
drying of the anode catalyst layer,
B) production of a second semifinished product by
application of a second ionomer layer to a second carrier,
application of a cathode catalyst layer to the second ionomer layer using a second catalyst ink,
drying of the cathode catalyst layer,
C) removal of the first and second carrier from the first and second ionomer layer, respectively, and joining of the first semifinished product to the second semifinished product by joining of the first ionomer layer to the second ionomer layer.

2. The process according to claim 1, wherein at least one of the first and second ionomer layers comprises from 0.5 to 35% of a solvent before step C) is carried out.

3. The process according to either claim 1, wherein the joining of the first semifinished product to the second semifinished product is effected either directly or indirectly via an intermediate membrane.

4. The process according to claim 1, wherein the first and second semifinished products have different area so that a projecting margin of a semifinished product remains after joining of the two semifinished products to form the catalyst coated membrane.

5. The process according to claim 1, wherein a frame is joined to a projecting margin of a semifinished product, a projecting margin of an intermediate membrane, a projecting margin of an ionomer layer or a projecting margin of the membrane.

6. The process according to claim 5, wherein the frame is joined on after the joining of the first semifinished product to the second semifinished product or after the application of the first or second ionomer layer and before the application of the anode or cathode catalyst layer.

7. The process according to claim 1, wherein the catalyst coated membrane is joined to a frame which comprises two frame halves of different sizes.

8. The process according to claim 1, wherein an intermediate frame is installed between two margins of ionomer layer projecting beyond the anode and cathode catalyst layers.

9. The process according to claim 1, wherein at least one of the anode and cathode catalyst layers is joined to a gas diffusion layer.

10. The process according to claim 9, wherein the anode catalyst layer is joined to a first gas diffusion layer and the cathode catalyst layer is joined to a second gas diffusion layer so that the first gas diffusion layer and the anode catalyst layer and also the second gas diffusion layer and the cathode catalyst layer are each flush or so that at least one of the first and second gas diffusion layers has a margin which projects beyond the anode or cathode catalyst layer.

11. The process according to claim 10, wherein the margin of gas diffusion layer at least partly overlaps a frame.

12. The process according to claim 1, wherein the catalyst coated membrane is joined to a frame and on each side to a gas diffusion layer and a gasket is installed on at least one transition region between the catalyst coated membrane or the frame and a gas diffusion layer.

13. The process according to claim 1, wherein at least one additional layer comprising an additive selected from the group consisting of solvents, solutions or a polyelectrolyte, dispersions of a polyelectrolyte, fillers and catalysts is applied between the two semifinished products before step C).

14. The process according to claim 1, wherein the first semifinished product is joined to the second semifinished product in step C), with the first and second semifinished products having different degrees of sulfonation of their ionomer layers.

15. The process according to claim 1, wherein at least one of the ionomer layers comprises at least one additional constituent selected from the group consisting of blend components, reinforcing fabrics, microporous support films and fillers.

16. A process for producing a membrane-electrode assembly for electrochemical devices, which comprises
i) application of a first ionomer layer to a carrier, application of a catalyst layer to the first ionomer layer using a catalyst ink, drying of the catalyst layer and removal of the carrier,
ii) application of a second ionomer layer to a gas diffusion electrode and
iii) joining of the first ionomer layer to the gas diffusion electrode to form a membrane-electrode assembly.

17. A catalyst coated membrane for electrochemical devices, which comprises at least two semifinished products joined to one another, namely a first semifinished product comprising a first ionomer layer joined to an anode catalyst layer and a second semifinished product comprising a second ionomer layer joined to a cathode catalyst layer, with a frame being joined to a projecting margin of a semifinished product, a projecting margin of an intermediate membrane, a projecting margin of an ionomer layer or a projecting margin of the membrane or is arranged as intermediate frame between two margins of ionomer layers.

18. A fuel cell comprising at least one catalyst coated membrane according to claim 17.
